(19) United States
(12) Patent Application Publication
(10) Pub. No.: US 2022/0136343 A1
(43) Pub. Date: May 5, 2022

(54) SYSTEM AND METHOD FOR HANDLING DRILL RODS

(71) Applicant: TITELINE SERVICES PTY LTD, Alfredton, Victoria (AU)

(72) Inventors: Gregory Kenneth WYTHES, Alfredton (AU); Grant BRIGGS, Alfredton (AU); Aaron ARNOLD, Alfredton (AU)

(21) Appl. No.: 17/431,242

(22) PCT Filed: Feb. 18, 2020
(86) PCT No.: PCT/AU2020/050133

§ 371 Date: Aug. 16, 2021

(30) Foreign Application Priority Data
Feb. 19, 2019 (AU) 2019900528

(51) Int. Cl. E21B 19/15; E21B 19/16

(52) U.S. Cl. CPC E21B 19/155; B25J 5/02; E21B 19/16

(57) ABSTRACT

A system for handling drill rods comprising: a rod carrier comprising a cassette body configured for storing at least one drill rod and an actuating mechanism configured to move the drill rod between a first position in the cassette body and a second position; a drilling rig comprising a mast adapted to receive the drill rod; and a manipulator configured to move the drill rod between the second position and the mast, wherein the system for handling drill rods also comprises at least one control unit configured to allow the manipulator to determine the location of the rod carrier and/or the drill rod and to direct handling of the drill rod between the second position and the mast.

### TECHNICAL FIELD

The present invention relates to a system and method for handling drill rods. In particular, the present invention relates to a system and method for handling drill rods in order to reduce or eliminate manual handling thereof.

### BACKGROUND ART

A drilling rig is a machine that creates holes in the earth's subsurface. Drilling rigs may be large structures used to drill water wells, oil wells, or natural gas extraction wells. Small to medium drilling rigs are typically mobile, and are used for, amongst other things, mineral exploration drilling, drilling blast-holes and for environmental investigations. Drilling machines typically comprise at least one drilling boom which is provided with a drilling unit to drill out the rock subsurface to create a drill hole. In most cases, the drill holes are of greater length than the length of a single drill rod, requiring two or more drill rods to be connected to one another by screwing the drill rods together to form an extended drill rod string.

A number of drill rods are typically stored in a rod carrier. Traditionally, drilling machines require the manual handling of drill rods between the rod carrier and the drilling machine which can be labour intensive as the rod carriers and the drill rods are heavy and dangerous to move and screw and unscrew together. Consequently, these tasks can be expensive with low efficiency.

Known machines which are used for semi-automating these working tasks such as that disclosed in EP3147448. However, this machine still requires the use of human operators (which can be represent a significant proportion of the total cost of mining cost) and limits the time period the machinery can be utilised (unless multiple human operators in shift work are used which increases labour cost).

More recently, robots are increasingly being used to automate labour intensive work to vastly increase machine utilisation and improve efficiency. In addition, robots can improve the consistency of the work performed which improves quality. Further, they can operate in situations which would be hazardous to humans e.g. in underground mine sites. All these factors increase efficiency and increase profits.

While dedicated robotic machines offer the advantages described above, they can also have the disadvantage that the cost to set up and maintain them can be high and their performance may not be significantly improved compared to manually operated machines.

Thus, there would be an advantage if it were possible to provide a machine that removed the requirement for manual handling of drill rods but that was also not prohibitively expensive.

### OBJECT OF THE INVENTION

The present invention is directed to a system and method for handling drill rods, which may at least partially overcome at least one of the abovementioned disadvantages or provide the consumer with a useful or commercial choice

### SUMMARY OF INVENTION

The present invention relates to autonomous mobile machines which provide for automation of mining activities which traditionally requires manual labour to improve productivity and therefore decrease costs.

With the foregoing in view, in a first aspect the invention resides broadly in a system for handling drill rods comprising:

a rod carrier comprising a cassette body configured for storing at least one drill rod and an actuating mechanism configured to move the drill rod between a first position in the cassette body and a second position;

a drilling rig comprising a mast adapted to receive the drill rod; and

a manipulator configured to move the drill rod between the second position and the mast,

wherein the system for handling drill rods also comprises at least one control unit configured to allow the manipulator to determine the location of the rod carrier and/or the drill rod and to direct handling of the drill rod between the second position and the mast.

In a second aspect, the invention resides broadly in a system for handling drill rods comprising:

a rod carrier comprising a cassette body configured for storing at least one drill rod;

a drilling rig comprising a mast adapted to receive the drill rod; and

a manipulator configured to move the drill rod between the rod carrier and the mast,

wherein the system for handling drill rods also comprises at least one control unit configured to allow the manipulator to determine the location of the rod carrier and/or the drill rod and to direct handling of the drill rod between the rod carrier and the mast.

In some embodiments of the invention, the rod carrier and the drilling rig each move independently of one another via at least one movement member. In other embodiments, the drilling rig may be adapted for movement relative to the rod carrier, while the rod carrier may not be provided with a movement member. The at least one movement members may be of any suitable form. For instance, the at least one movement member may comprise one or more wheels, slides, rollers and the like, or any combination thereof. In a preferred embodiment of the invention, the at least one movement member may comprise an endless track. In a preferred embodiment of the invention, each of the drilling rig and the rod carrier is provided with one or more endless tracks.

In some embodiments of the invention, the rod carrier may be removably or fixedly connected to the drilling rig such that the rod carrier and the drilling rig are incapable of independent movement relative to one another. In other embodiments, the rod carrier may be mounted on the drilling rig.

In some embodiments, the rod carrier and the drilling rig may each comprise a vision system comprising at least one vision sensor to detect terrain and/or obstacles. The vision system may comprise at least one camera, such as, but no limited to, a stereo camera. The at least one camera may be used to locate the rod carrier or the drilling rig. In one embodiment, the at least one camera may be positioned on top of the rod carrier and/or the drilling rig so as to have an unimpeded view of the surrounding terrain.

The manipulator may be located at any suitable point within the system. For instance, in some embodiments of the invention, the manipulator may be located on the drilling rig. Alternatively, the manipulator may be located on the rod carrier. In some embodiments, a manipulator may be located on each of the drilling rig and the rod carrier.

The manipulator may be of any suitable form. In a preferred embodiment of the invention, the manipulator may include a gripper. The gripper may be of any suitable form, and may comprise one or more wheels, rollers, magnets, hooks, fingers or the like adapted to grip the drill rod. The method of moving a drill rod by the manipulator may comprise sensing the location of the rod carrier; approaching the vicinity of the drill rod via movement of the arm of the manipulator; actuating the gripper to grip the drill rod; and moving the gripped drill rod to the drilling rig via movement of the arm.

Preferably, the gripper also comprises at least one pressure sensor configured to sense the pressure on a drill rod surface when the gripper contacts the drill rod. In this manner, the gripper may grip the drill rod without applying either excessive pressure to the drill rod (which could result in damage to the drill rod) or insufficient pressure to the drill rod (which could result in the drill rod being dropped).

In a preferred embodiment of the invention, the manipulator further comprises at least one arm. The at least one arm may be of any suitable form. Preferably, however, the at least one arm comprises a robotic arm. Any suitable robotic arm may be provided, and the robotic arm may be provided with any suitable number of axes, although it will be understood that varying the axes of the robotic arm, the operation of the system may be altered in order to tailor the system to suit environmental factors or operational considerations. In a preferred embodiment of the invention, however, the robotic arm may be provided with 7 axes. Thus, the movement of the at least one robotic arm may have 7 degrees of freedom (7 DOF).

As previously stated, the manipulator is configured to move the drill rod between the rod carrier and the mast. The drill rod may be retrieved by the manipulator from any suitable location. For instance, in the second aspect of the invention, the drill rod may be retrieved from the interior of the rod carrier. The drill rod may be retrieved from any suitable location within the rod carrier, including a rack or cradle in which the drill rod is stored when not in use. In the first aspect of the invention, however, the drill rod may be moved from a first position within the rod carrier (for instance, from within a rack, cradle or similar storage system in which drill rods not in use may be stored) to a second position. The second position may be at any suitable location. For instance, the second position may be within the cassette body at a location other than the first position. Alternatively, the second position may be external to the cassette body. For instance, the drill rod may be still be associated with the rod carrier when in the second position but at a point external to the cassette body. In embodiments in which the second position is external to the cassette body, the drill rod may exit the cassette body to move into the second position through any suitable part of the cassette body, such as a side of the cassette body, an end of the cassette body, a top of the cassette body or a bottom of the cassette body. In specific embodiments of the invention, the second position may be located at the right side of the rod carrier, to the right side of the rod carrier and projected forwards or backwards, to the left side of the rod carrier and/or to the left side of the rod carrier and projected forwards or backwards. In these embodiments of the invention, the drill rod may exit the cassette body into a drill rod holder associated with the rod carrier. The drill rod holder may be configured for movement relative to the cassette body. Thus, the drill rod holder may move relative to the cassette body to deliver the drill rod to the second position (e.g. projected forwards or backwards of the cassette body). Preferably, at least a portion of the drill rod holder and/or the drill rod may project forwards or backwards of the cassette body. In this way, particularly in confined or relatively inaccessible locations, the drill rod may be more readily delivered to a second position that places the drill rod within reach of the manipulator. In some embodiments of the invention, the rod carrier may be provided with a single drill rod holder. More preferably, however, the rod carrier may be provided with a pair of drill rod holders. In this embodiment, it is envisaged that a first of the pair of drill rod holders may be provided on a first side of the rod carrier, while a second of the pair of drill rod holders may be provided on an opposed second side of the rod carrier.

It is envisaged that, in some embodiments of the invention, the manipulator may return the drill rod to the rod carrier once the drill rod has been disconnected from the mast. The manipulator may return the drill rod to any suitable location. For instance, the manipulator may return the drill rod to the first position or the second position. Alternatively, the manipulator may return the drill rod to a different position either internally or externally to the cassette body.

Preferably, the drill operation may comprise attaching the drill rod to a drill rod string (or the mast) in the drilling position or detaching the drill rod from a drill rod string (or the mast) in the drilling position. However, other drill operations could be used without departing from the scope of the present invention.

In a preferred embodiment of the invention, the drilling rig may include a chassis. In this embodiment of the invention, the manipulator may be associated with the chassis. The manipulator may be mounted directly to the chassis. Alternatively, the manipulator may be adapted for movement relative to the drilling rig (and the chassis). It is envisaged that the movement of the manipulator relative to the drilling rig (and the chassis) may comprise the movement of the robotic arm in its degrees of freedom. More preferably, however, the movement of the manipulator relative to the drilling rig (and the chassis) may comprise both the movement of the robotic arm in its degrees of freedom and a movement of the entire robotic arm relative to the chassis. In this embodiment of the invention, it is envisaged that the drilling rig may further comprise a track with which the manipulator may be associated. In this embodiment of the invention, it is envisaged that the manipulator may be adapted for movement along the track. Thus, the manipulator may collect the drill rod from the rod carrier located at one end of the drilling rig then move along the track to a position close to or adjacent the mast so as to connect the drill rod to the mast.

The track may extend for any length and in any direction on the drilling rig. For instance, the track may be located on an upper surface and/or a side edge of the drilling rig. The track may be linear, curved or may include one or more bends or corners therein. Preferably, the track allows the manipulator to move relative to the drilling rig such that the manipulator is capable of collecting the drill rod from the rod carrier regardless of where the rod carrier is positioned relative to the drilling rig. It will be understood, of course, that the rod carrier needs to be sufficiently close to the drilling rig that the drill rod is within reach of the manipulator.

The manipulator may be associated with the track in any suitable manner. For instance, the manipulator may slide relative to the track. Alternatively, the manipulator may be associated with one or more rollers, wheels or the like so that the manipulator rolls along the track. In other embodiments of the invention, the manipulator may be associated with a drive mechanism adapted to move the manipulator relative to the track. Any suitable drive mechanism may be provided such as, but not limited to, a belt drive, chain drive or the like.

In some embodiments of the invention, the rod carrier may be associated with the drilling rig. In this embodiment of the invention, it is envisaged that the rod carrier may be mounted on the drilling rig, and, more specifically, to the chassis of the drilling rig. In this embodiment of the invention, the manipulator may be configured to retrieve a rod from the rod carrier mounted on the drilling rig and move the rod to the mast for connection to the string, or to disconnect a drill rod from the string and return it to the rod carrier.

In some embodiments of the invention the drilling rig and the rod carrier may be autonomous. In other embodiments of the invention, the drilling rig and the rod carrier may be semi-autonomous. In this embodiment, it is envisaged that the drilling rig and the rod carrier may be adapted to be controlled remotely by an operator. The operator may control the drilling rig and the rod carrier using any suitable technique. For instance, the operator may be provided with a controller. The controller may be connected by one or more wires to the drilling rig and/or the rod carrier. More preferably, the operator may control the drilling rig and the rod carrier remotely. In this embodiment of the invention, it is envisaged that a wireless connection may be provided between the controller operated by the operator and the drilling rig and/or rod carrier.

In some embodiments, the at least one control unit may be adapted for connection to a control device operated by the operator. The at least one control unit may be connected to a control device in any suitable manner. For instance, the control unit and the control device may be physically connected, such as via one or more electrical wires, cables or the like. Alternatively, the control unit and the control device may be wirelessly connected to one another, such as by using Wi-Fi, Bluetooth or the like. In embodiments of the invention in which a wireless communication network is not present or not available, it is envisaged that data generated by the system may be logged and/or displayed in a human-machine interface (HMI), programmable logic controller (PLC) or a data logger.

In some embodiments, it is envisaged that data generated by the rod carrier and the drilling rig during use may be adapted to be read in real-time by the remote operator. The use of a Global Positioning System (GPS) may enable the location of the rod carrier and the drilling rig to be known by the remote operator.

It is envisaged that the system for handling drill rods may include software. The software may be of any suitable form, although in a preferred embodiment of the invention the software is embedded software. Preferably, the software may be written using PLC programming software. It is envisaged that the drilling rig and/or the rod carrier may be provided with one or more sensors that provide data to the PLC in order to facilitate operation of the system. The sensors may be of any suitable form, although in a preferred embodiment of the invention, the sensors may be associated with one or more Input/Output (I/O) modules, and./or a PLC. Preferably, the operation of the system is through functional sequences and interlocks written into the software.

The system for handling drill rods may also comprise at least one light detection and ranging (LIDAR) laser scanner configured to survey the terrain. In this embodiment, the scanned terrain may be used by the control unit (and embedded software where present) to control the movement of the rod carrier and the drilling rig. The autonomous mobile machine preferably has at least one Light Detection and Ranging (LIDAR) laser scanner system configured to survey the terrain and measure the distance to a target drill rod by illuminating the target with pulsed laser light and measuring the reflected pulses with a sensor. It is envisaged that differences in laser return times and wavelengths may be used to generate 3-D representations of the terrain, and more preferably digital 3-D representations of the terrain.

Preferably, the system for handling drill rods also comprises at least one position sensor configured to sense the position of the rod carrier and/or the drilling rig in the terrain, wherein the sensed vehicle position is used by the control unit to establish a change in position in the terrain over time to autonomously control the steering and acceleration of the system for handling drill rods to a particular location in the terrain. Alternatively, at least one position sensor is a track encoder configured to establish the distance the system for handling drill rods has been moved relative to a start position via the wheel diameter or track length and the speed.

Preferably, the system for handling drill rods also comprises at least one arm position sensor configured to sense the position of the arm in the terrain. In this embodiment, the sensed arm position may be used by the control unit to autonomously control the reach and angle of the arm. Preferably, the system for handling drill rods also comprises at least one collision sensor configured to sense collision hazards in the terrain, such as people in its vicinity.

In a third aspect, the invention resides broadly in a method for handling drill rods comprising the steps of:

a. positioning a rod carrier and a drilling rig in relative proximity to one another;

b. moving a drill rod from a first position in a body of the rod carrier and a second position;

c. moving a manipulator into the vicinity of the drill rod;

d. gripping the drill rod with the manipulator; and

e. moving the drill rod to the mast of the drilling rig.

The reverse of the above method steps (a) to (e) is used when moving a drill rod from the drilling rig to the rod carrier for storage.

In a fourth aspect, the invention resides broadly in a method for handling drill rods comprising the steps of:

a. positioning a rod carrier and a drilling rig in relative proximity to one another;

b. moving a manipulator into the vicinity of the rod carrier;

c. retrieving a drill rod from the rod carrier using the manipulator;

d. moving the drill rod to the mast of the drilling rig.

The reverse of the above method steps (a) to (d) is used when moving a drill rod from the drilling rig to the rod carrier for storage.

The rod carrier and the drilling rig may be positioned in relative proximity to one another using any suitable technique. For instance, the rod carrier and the drilling rig may be autonomous vehicles adapted to automatically move into relative proximity to one another. Alternatively, an operator may manually move the rod carrier and the drilling rig into relative proximity to one another. This may be achieved using any suitable technique, although in some embodiments the rod carrier and the drilling rig may be moved into relative proximity to one another via a controller operated by an operator. The controller may be connected by one or more wires to the drilling rig and/or the rod carrier. More preferably, the operator may control the drilling rig and the rod carrier remotely. In this embodiment of the invention, it is envisaged that a wireless connection may be provided between the controller operated by the operator and the drilling rig and/or the rod carrier.

In some embodiments of the invention, the rod carrier and the drilling rig may be moved relative to one another. However, it is envisaged that the position of the drilling rig may be determined by the location at which a drill hole is required. Thus, in some embodiments of the invention, the location of the drilling rig may necessarily be fixed. In these embodiments, it is envisaged that the rod carrier may be moved into relative proximity with the drilling rig.

It is envisaged that, in some embodiments, the rod carrier may move relative to the drilling rig during the movement of subsequent drill rods between the rod carrier and the mast if, for instance, obstacles appear that would prevent movement of a drill rod between the rod carrier and the mast. More preferably, however, the rod carrier may be moved into relative proximity to the drilling rig at the commencement of the connection to, or disconnection from, the mast of a drill rod string, and the rod carrier may then remain in the same position relative to the drilling rig for substantially the entire process.

The proximity of the drilling rig and the rod carrier to one another may be determined by a number of factors, such as the available space, the size of the drilling rig and/or the rod carrier and so on. Preferably, however, the term “relative proximity” will mean that, when positioned relative to one another, the manipulator is capable of both retrieving a drill rod from the rod carrier and moving the drill rod to the mast of the drilling rig.

In a fifth aspect, the invention resides broadly in a drilling rig comprising a chassis, a drive portion mounted on the chassis, the drive portion being in communication with one or more movement members, the drilling rig further comprising a mast and a manipulator associated with the chassis and adapted for movement relative thereto, and wherein the manipulator is adapted to connect a drill rod to, and remove a drill rod from, the mast.

It is envisaged that the term “connecting the drill rod to, or disconnecting the drill rod from, the mast” is intended to cover both a situation in which a drill rod is the first drill rod in a drill rod string and a situation in which a drill rod is connected to another drill rod in a drill rod string. Preferably, drill rods are connected to, or disconnected from a mast and/or drill string via a screw-threaded connection.

The chassis of the drilling rig may be of any suitable form. Indeed, it is envisaged that the chassis may be relatively conventional in construction. However, it will also be understood that the chassis must be provided with sufficient space to allow the manipulator to be associated therewith and movable relative thereto.

The manipulator may be of any suitable form. However, in a preferred embodiment of the invention the manipulator may comprise at least one arm. The at least one arm may be of any suitable form. Preferably, however, the at least one arm comprises a robotic arm. Any suitable robotic arm may be provided, although in a preferred embodiment of the invention, the robotic arm may be provided with 7 axes. Thus, the movement of the at least one robotic arm may have 7 degrees of freedom (7 DOF).

It is envisaged that the movement of the manipulator relative to the chassis may comprise the movement of the robotic arm in its degrees of freedom. More preferably, however, the movement of the manipulator relative to the chassis may comprise both the movement of the robotic arm in its degrees of freedom and a movement of the entire robotic arm relative to the chassis. In this embodiment of the invention, it is envisaged that the chassis may further comprise a track with which the manipulator may be associated. In this embodiment of the invention, it is envisaged that the manipulator may be adapted for movement along the track. Thus, the manipulator may collect a drill rod (for instance, from a rod carrier) located at one end of the drilling rig then move along the track to a position close to or adjacent the mast so as to connect the drill rod to the mast.

The track may extend for any length and in any direction on the drilling rig. For instance, the track may be located on an upper surface and/or a side edge of the chassis. The track may be linear, curved or may include one or more bends or corners therein. Preferably, the track allows the manipulator to move relative to the chassis such that the manipulator is capable of collecting the drill rod from the rod carrier regardless of where the rod carrier is positioned relative to the drilling rig. It will be understood, of course, that the rod carrier needs to be sufficiently close to the drilling rig that the drill rod is within reach of the manipulator.

The manipulator may be associated with the track in any suitable manner. For instance, the manipulator may slide relative to the track. Alternatively, the manipulator may be associated with one or more rollers, wheels or the like so that the manipulator rolls along the track. In other embodiments of the invention, the manipulator may be associated with a drive mechanism adapted to move the manipulator relative to the track. Any suitable drive mechanism may be provided such as, but not limited to, a belt drive, chain drive or the like.

Preferably, the manipulator comprises a gripper configured for gripping the drill rod. The gripper may be of any suitable form, and may comprise one or more wheels, rollers, magnets, hooks, fingers or the like adapted to grip the drill rod. Preferably, the gripper comprises at least two grip members for gripping the drill rod. The method of moving a drill rod by the manipulator may comprise sensing the location of the rod carrier; approaching the vicinity of the drill rod in the second position via movement of the arm of the manipulator; actuating the gripper to grip the drill rod; and moving the gripped drill rod to the drilling rig via movement of the arm.

Preferably, the gripper also comprises at least one pressure sensor configured to sense the pressure on a drill rod surface when the gripper contacts the drill rod. In this manner, the gripper may grip the drill rod without applying either excessive pressure to the drill rod (which could result in damage to the drill rod) or insufficient pressure to the drill rod (which could result in the drill rod being dropped).

The drive portion may be of any suitable form. Preferably, however, the drive portion may be adapted to drive movement of the drilling rig. Thus, in a preferred embodiment of the invention, the drive portion may comprise an engine or motor. Any suitable engine or motor may be provided, such as, but not limited to, an internal combustion engine, electric motor, battery operated motor, solar powered motor or the like, or a combination thereof.

It is envisaged that the drive portion will be in communication with the movement members, such as actuation of the drive portion may result in movement of the movement members which in turn may drive movement of the drilling rig. The movement members may be of any suitable form. For instance, the movement members may comprise one or more wheels, slides, rollers and the like, or any combination thereof. In a preferred embodiment of the invention, the movement members may comprise endless tracks. In a preferred embodiment of the invention, the drilling rig may be provided with a pair of endless tracks.

The connection between the drive portion and the movement members is largely conventional, and no further discussion of this is required.

In a preferred embodiment of the invention, the drilling rig is a semi-autonomous drilling rig. Alternatively, the drilling rig may be an autonomous drilling rig.

In some embodiments, the drilling rig may include at least one control unit. In some embodiments, the at least one control unit may be adapted for connection to a control device operated by the operator. The at least one control unit may be connected to a control device in any suitable manner. For instance, the control unit and the control device may be physically connected, such as via one or more electrical wires, cables or the like. Alternatively, the control unit and the control device may be wirelessly connected to one another, such as by using Wi-Fi, Bluetooth or the like. In embodiments of the invention in which a wireless communication network is not present or not available, it is envisaged that data generated by the drilling rig may be logged and/or displayed in a human-machine interface (HMI), programmable logic controller (PLC) or a data logger.

It is envisaged that the control unit may include software. The software may be of any suitable form, although in a preferred embodiment of the invention the software is embedded software. Preferably, the software may be in the form of a Controller Area Network (CAN bus). The particular implementation of the CAN bus would be known by a person skilled in the art and a matter of routine implementation.

The drilling rig may also comprise at least one light detection and ranging (LIDAR) laser scanner configured to survey the terrain. In this embodiment, the scanned terrain may be used by the control unit (and embedded software where present) to control the movement of the drilling rig. The autonomous mobile machine preferably has at least one Light Detection and Ranging (LIDAR) laser scanner system configured to survey the terrain and measure the distance to a target drill rod by illuminating the target with pulsed laser light and measuring the reflected pulses with a sensor. It is envisaged that differences in laser return times and wavelengths may be used to generate 3-D representations of the terrain, and more preferably digital 3-D representations of the terrain.

Preferably, the drilling rig also comprises at least one position sensor configured to sense the position of the drilling rig in the terrain, wherein the sensed vehicle position is used by the control unit to establish a change in position in the terrain over time to autonomously control the steering and acceleration of the drilling rig to a particular location in the terrain. Alternatively, at least one position sensor is a track encoder configured to establish the distance the drilling rig has been moved relative to a start position via the wheel diameter or track length and the speed.

Preferably, the drilling rig also comprises at least one arm position sensor configured to sense the position of the arm in the terrain. In this embodiment, the sensed arm position may be used by the control unit to autonomously control the reach and angle of the arm. Preferably, the drilling rig also comprises at least one collision sensor configured to sense collision hazards in the terrain, such as people in its vicinity.

In all aspects of the invention in which a mast is present, it is envisaged that the mast may be adapted for movement relative to the drilling rig. Specifically, the mast may be movable between a retracted condition and an extended condition. It is envisaged that, in the extended condition, the mast may be positioned substantially vertically. The drilling rig may be used to drill when the mast is in the extended condition, although it will also be understood that the mast may be positioned in a plurality of intermediate use conditions between the retracted condition and the extended condition. For instance, drilling may take place at an angle other than 90° to the horizontal.

It is envisaged that the mast may be positioned in the retracted condition when, for example, the drilling rig is being moved or transported, when moving in confined spaces (such as with low ceilings) and so on. Thus, in the retracted condition it is preferred that the mast may be moved out of the substantially vertical extended condition or the one or more intermediate use conditions. In one embodiment, the mast may be positioned substantially horizontally, although it will be understood that this need not necessarily be the case and that the purpose of the retracted condition is simply to ensure that the mast is not at its full height. Thus, the mast may be positioned at any suitable angle to the vertical in the retracted condition (but not positioned vertically). In some embodiments of the invention, the mast may transition between the extended condition where it is positioned substantially vertically, to the retracted condition in which it is positioned substantially horizontally on the drilling rig, or the chassis of the drilling rig.

In a preferred embodiment of the invention, the drilling rig may include a communication portion. In this embodiment of the invention, it is envisaged that the communication portion may issue a signal to a rod carrier when the drilling rig requires a drill rod. It is envisaged that, upon receipt of the signal from the drilling rig, the rod carrier may prepare a drill rod for retrieval by the manipulator.

The signal may be of any suitable form. Preferably, however, the signal is an electronic signal sent by a communication portion of the drilling rig. Preferably, the signal is sent wirelessly from the communication portion of the drilling rig to the communication portion of the rod carrier.

In some embodiments of the invention, the drilling rig may be adapted to insert and retrieve tubes from the drill hole formed by the drilling rig. In addition, it is envisaged that the manipulator may be adapted to break down joints, such as joints between drill rods in a string and so on. The manipulator may be adapted to break down any suitable joint, such as screw-threaded joints, frictional connections, barrel joints or the like, or any suitable combination thereof.

In a sixth aspect, the invention resides broadly in a rod carrier, the rod carrier comprising a drive portion, the drive portion being in communication with one or more movement members, the rod carrier further comprising a cassette body configured for storing at least one drill rod and an actuating mechanism configured to move the drill rod between a first position in the cassette body and a second position.

The drive portion may be of any suitable form. Preferably, however, the drive portion may be adapted to drive movement of the rod carrier. Thus, in a preferred embodiment of the invention, the drive portion may comprise an engine or motor. Any suitable engine or motor may be provided, such as, but not limited to, an internal combustion engine, electric motor, battery operated motor, solar powered motor or the like, or a combination thereof.

It is envisaged that the drive portion will be in communication with the movement members, such as actuation of the drive portion may result in movement of the movement members which in turn may drive movement of the rod carrier. The movement members may be of any suitable form. For instance, the movement members may comprise one or more wheels, slides, rollers and the like, or any combination thereof. In a preferred embodiment of the invention, the movement members may comprise endless tracks. In a preferred embodiment of the invention, the rod carrier may be provided with a pair of endless tracks.

The connection between the drive portion and the movement members is largely conventional, and no further discussion of this is required.

In a preferred embodiment of the invention, the rod carrier is a semi-autonomous rod carrier. Alternatively, the drilling rig may be an autonomous rod carrier.

In some embodiments, the rod carrier may include at least one control unit. In some embodiments, the at least one control unit may be adapted for connection to a control device operated by the operator. The at least one control unit may be connected to a control device in any suitable manner. For instance, the control unit and the control device may be physically connected, such as via one or more electrical wires, cables or the like. Alternatively, the control unit and the control device may be wirelessly connected to one another, such as by using Wi-Fi, Bluetooth or the like. In embodiments of the invention in which a wireless communication network is not present or not available, it is envisaged that data generated by the rod carrier may be logged and/or displayed in a human-machine interface (HMI), programmable logic controller (PLC) or a data logger.

It is envisaged that the control unit may include software. The software may be of any suitable form, although in a preferred embodiment of the invention the software is embedded software. Preferably, the software may be in the form of a Controller Area Network (CAN bus). The particular implementation of the CAN bus would be known by a person skilled in the art and a matter of routine implementation.

The rod carrier may also comprise at least one light detection and ranging (LIDAR) laser scanner configured to survey the terrain. In this embodiment, the scanned terrain may be used by the control unit (and embedded software where present) to control the movement of the rod carrier. The autonomous mobile machine preferably has at least one Light Detection and Ranging (LIDAR) laser scanner system configured to survey the terrain and measure the distance to a drilling rig by illuminating the target with pulsed laser light and measuring the reflected pulses with a sensor. It is envisaged that differences in laser return times and wavelengths may be used to generate 3-D representations of the terrain, and more preferably digital 3-D representations of the terrain.

Preferably, the rod carrier also comprises at least one position sensor configured to sense the position of the rod carrier in the terrain, wherein the sensed vehicle position is used by the control unit to establish a change in position in the terrain over time to autonomously control the steering and acceleration of the rod carrier to a particular location in the terrain. Alternatively, at least one position sensor is a track encoder configured to establish the distance the rod carrier has been moved relative to a start position via the wheel diameter or track length and the speed.

The cassette body may be of any suitable form. Preferably, however, the cassette body comprises a storage portion for the one or more drill rods. Preferably, the cassette body is configured to store a plurality of drill rods. The cassette body may be at least partially enclosed. In other embodiments of the invention, the cassette body may be entirely enclosed.

The drill rods may be stored in any suitable manner within the cassette body. For instance, the drill rods may be loose within the cassette body. Alternatively, the drill rods may be stored in racks, cradles or the like within the cassette body. In this embodiment of the invention, it is envisaged that the drill rods are located in the first position when in the racks. The drill rods may be retrieved by the manipulator from the first position, or an actuating mechanism may retrieve the drill rod from the rack and move it to the second position, from where the manipulator may retrieve the drill rod.

In some embodiments of the invention, the racks in which the drill rods are stored may be fixed in position. Thus, in this embodiment of the invention, the actuating mechanism may comprise a manipulator adapted to retrieve the drill rods from the racks and move the drill rod to the second position. Any suitable manipulator may be provided, such as, but not limited to, a robotic arm.

Alternatively, the racks in which the drill rods are stored may be movable relative to the cassette body. In this embodiment of the invention a rack containing a drill rod may be moved to a position adjacent the actuating mechanism so that the actuating mechanism may be moved between the first position in the rack and the second position. The racks may be moved relative to the cassette body using any suitable technique. Preferably, however, a drive portion (such as a motor or the like) may actuate a drive member (such as a chain drive, belt drive or the like) to move the racks relative to the cassette body.

In another embodiment of the invention, the drill rods may be stacked within the cassette body. In this embodiment it is envisaged that the drill rods may be stacked on top of one another. It is envisaged that a drill rod at the bottom of a stack may be moved into the second position, at which time the remaining drill rods in the stack move downwards to replace the removed drill rod. Thus, further drill rods may be removed from the bottom of the stack. In this embodiment of the invention, it is envisaged that a housing, a plurality of channels or the like may be provided within the cassette body in which the drill rods are stacked on top of one another.

When a drill rod is in the first position adjacent the actuating mechanism, the actuating mechanism may actuate to move the drill rod from the first position to the second position. The actuating mechanism may be associated with a drive member, such as a motor, that drives the actuating mechanism.

The actuating mechanism may be of any suitable form and may comprise one or more rod movement members adapted to move the rod between the first position and the second position. The rod movement members may comprise one or more grippers adapted to grip the drill rod and move it from the first position to the second position. Alternatively, the one or more rod movement members may comprise one or more rod lifters. In a specific embodiment of the invention, the one or more rod lifters may remove the rod from the first position (for instance, in a rack or cradle) and place the rod on a transport mechanism, such as, but not limited to, a chain drive mechanism, conveyor or the like. It is envisaged that, once the rod is placed on the transport mechanism, the transport mechanism may transport the rod to the second position.

In a preferred embodiment of the invention, the rod carrier may include a communication portion. In this embodiment of the invention, it is envisaged that the communication portion may receive a signal from a drilling rig when the drilling rig requires a drill rod. It is envisaged that, upon receipt of the signal from the drilling rig, the actuating mechanism may actuate to move a drill rod into the second position external to the body of the rod carrier.

The signal may be of any suitable form. Preferably, however, the signal is an electronic signal sent by a communication portion of the drilling rig. Preferably, the signal is sent wirelessly from the communication portion of the drilling rig to the communication portion of the rod carrier.

The present invention provides a number of advantages over the prior art. For instance, the present invention improves production efficiency by providing for automatic drill rod movement between storage in a rod carrier and use in a drilling rig, decreases safety hazards to personnel by obviating the need for manual drill rod handling, allows for effective handling of drill rods even in confined spaces (such as underground mines and the like) and allows for remote and/or autonomous operation or control of the drilling rig and the rod carrier, reducing or eliminating the need for operators to be located in remote or dangerous environments.

Any of the features described herein can be combined in any combination with any one or more of the other features described herein within the scope of the invention.

The reference to any prior art in this specification is not, and should not, be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates an isometric view of a system for handling drill rods comprising a rod carrier and a drilling rig according to an embodiment of the present invention.

FIG. 2 illustrates an isometric view of a system for handling drill rods comprising a rod carrier and a drilling rig according to an embodiment of the present invention.

FIG. 3 illustrates an isometric view of a rod carrier according to an embodiment of the present invention.

FIG. 4 illustrates an isometric view of a rod carrier according to an embodiment of the present invention.

FIG. 5 illustrates an isometric view of a drilling rig according to an embodiment of the present invention.

FIG. 6 illustrates an isometric view of a drilling rig according to an embodiment of the present invention.

### DETAILED DESCRIPTION OF THE DRAWINGS

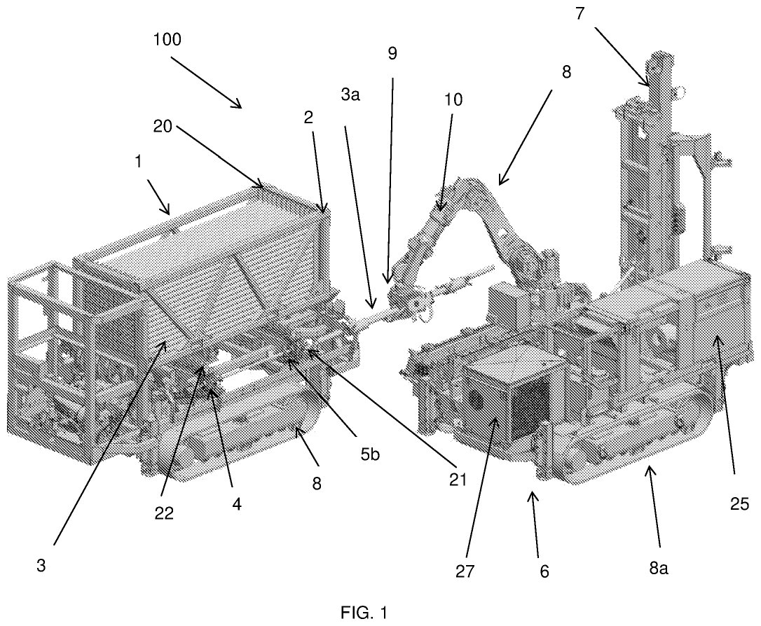

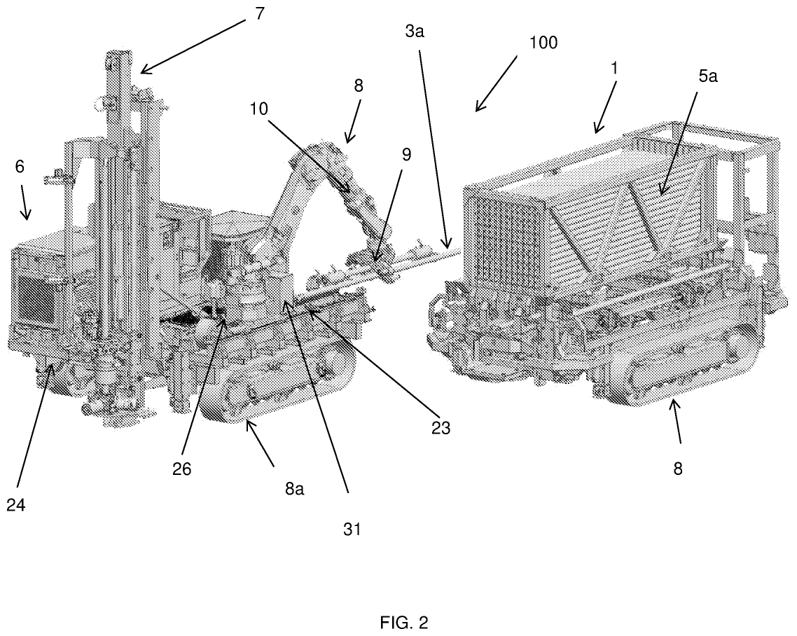

FIGS. 1 and 2 illustrate isometric views of a system for handling drill rods according to an embodiment of the present invention. The system for handling drill rods is generally indicated by arrow 100. The system for handling drill rods 100 comprises a rod carrier 1 comprising a cassette body 2 configured for storing drill rods 3. In FIG. 1, the rod carrier 1 is provided with an actuating mechanism 4 configured to move a drill rod 3 between a first position 5a within the cassette body 2 and a second position 5b external to the cassette body 2 for subsequent pickup.

The drill rods 3 in the first position 5a within the cassette body 2 are stacked on top of one another in a plurality of channels 20. Drill rods 3 to be moved from the channels 20 to the second position 5b are retrieved from the bottom of the channels 20 by the actuating mechanism 4. The actuating mechanism 4 comprises a pair of rod lifters 21 adapted to lift the retrieved drill rod 3a, the rod lifters 21 being associated with a chain drive mechanism 22 that moves the retrieved drill rod 3a between the first position 5a and the second position 5b.

The system for handling drill rods 100 also comprises a drilling rig 6 comprising a mast 7 to which drill rods 3 are connected in order to drill holes into a desired orientation for drilling and a manipulator (indicated generally by arrow 8) comprising a gripper 9 configured for gripping the retrieved drill rod 3a and a robotic arm 10 configured to position the gripper 9 in the vicinity of the rod carrier 1 in order to retrieve the drill rod 3a from the rod carrier 1 and move it between the second position 5b and the drilling rig 6 for a drill operation such as attaching to a drill rod string (not shown in these Figures) to the mast 7 or detaching the drill rod 3a from a drill rod string (not shown in these Figures) from the mast 7.

The rod carrier 1 and the drilling rig 6 each move independently of one another via endless tracks (8 and 8a respectively).

Movement of the manipulator 8 relative to the track 23 is driven by powerpack 25. The powerpack 25 also drives operation of the drill.

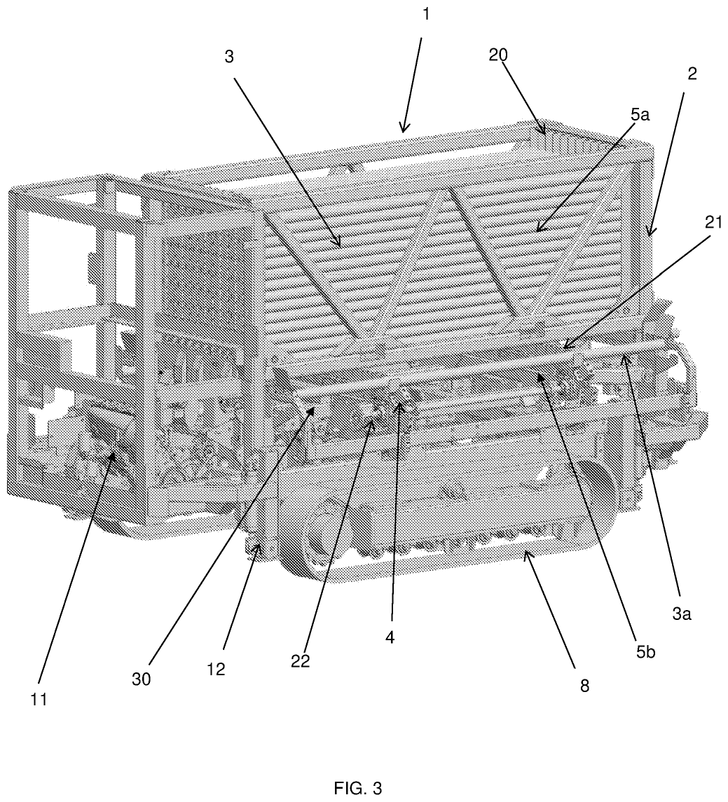

FIG. 3 illustrates an isometric view of a rod carrier 1 according to an embodiment of the present invention. The rod carrier 1 includes a cassette body 2 in which are stored a plurality of drill rods 3. In this embodiment, the drill rods 3 are stored in channels 20 within the cassette body 2.

When the rod carrier 1 is in a location where it is to be used (or, for instance, on uneven or unstable ground) stabiliser legs 12 may be deployed to help maintain the rod carrier 1 in position

A motor 11 drives the endless track 8 of the rod carrier 1 to provide for movement of the rod carrier 1. The motor 11 also drives the actuating mechanism 4 to deliver drill rods 3 from the first position in the storage position in the rod carrier body 2 and the second position 5b for pickup by the robotic arm 10.

In the embodiment of the invention shown in FIG. 3, the retrieved drill rod 3a exits the cassette body 2 at the side thereof and is received a drill rod holder 30. The retrieved drill rod 3a is retrieved from the drill rod holder 30 by the manipulator (not shown in this Figure).

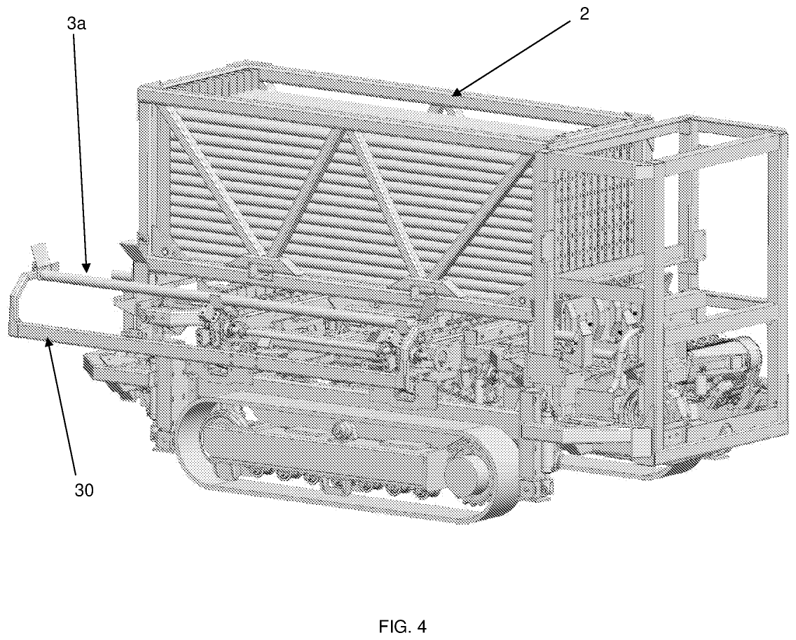

The drill rod holder 30 is adapted for movement relative to the cassette body 2. As best seen in FIG. 4, the drill rod holder 30 is adapted to move so that a portion of the drill rod holder 30 and the retrieved drill rod 3a projects forwards of the cassette body 2. In this way, if the drilling rig (not shown in this Figure) and, more specifically, the manipulator (not shown in this Figure) is unable to reach the drill rod 3a when the drill rod holder 30 is in the position shown in FIG. 3, the drill rod holder 30 can be moved relative to the cassette body 2 as shown in FIG. 4 so as to place the drill rod 3a within reach of the manipulator (not shown in this Figure).

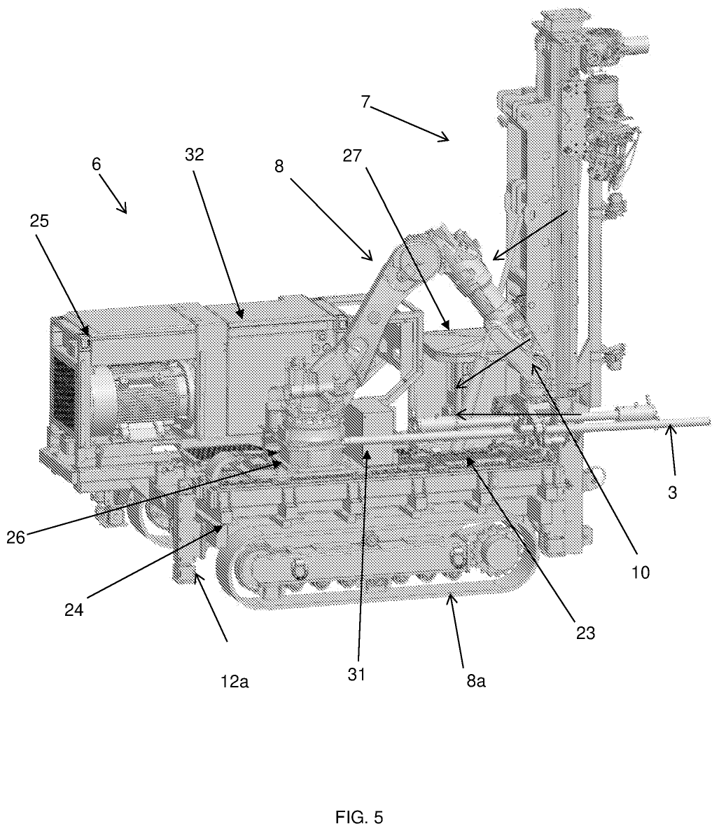

FIG. 5 illustrates an isometric view of a drilling rig 6 according to an embodiment of the present invention. The drilling rig 6 includes a chassis 24 to which is mounted a drive portion in the form of a motor 27. The motor 27 drives the endless track 8a to provide for movement of the drilling rig 6. The drilling rig 6 is stabilised in an operating position by hydraulically activated stabiliser legs 12a.

The manipulator 8 is mounted on a track 23 that is in turn mounted on the chassis 24. The manipulator 8 is adapted for movement relative to the track 23. In this way, the manipulator 8 can retrieve a drill rod 3 from the rod carrier (not shown in this Figure) regardless of the position of the rod carrier relative to the drilling rig 6. For instance, the manipulator 8 can move along the track 23 relative to the chassis 24 in order to move the manipulator 8 within reach of the rod carrier (not shown in this Figure) so that the robotic arm 10 can be actuated to retrieve a drill rod 3 from the rod carrier.

Movement of the manipulator 8 relative to the track 23 is driven by powerpack 25. In the embodiment of the invention shown in FIG. 4, the powerpack 25 actuates motor 31 to drive a base 26 on which the manipulator 8 is positioned relative to the track 23 via a rack and pinion mechanism.

A control unit 32 allows the rod carrier 1 and the drilling rig 6 to communicate with one another. It is envisaged that the rod carrier 1 and the drilling rig 6 may communicate with one another so that the manipulator 8 can determine the precise location of the rod carrier 1 and, more specifically, the precise location of the drill rod 3 to be retrieved. In this way, the manipulator 8 may move relative to the chassis 24 of the drilling rig 6 in order to move into relatively close proximity to the rod carrier 1 (and the drill rod 3) so that the manipulator 8 may retrieve the drill rod 3 from the rod carrier 1 and move it to the mast 7.

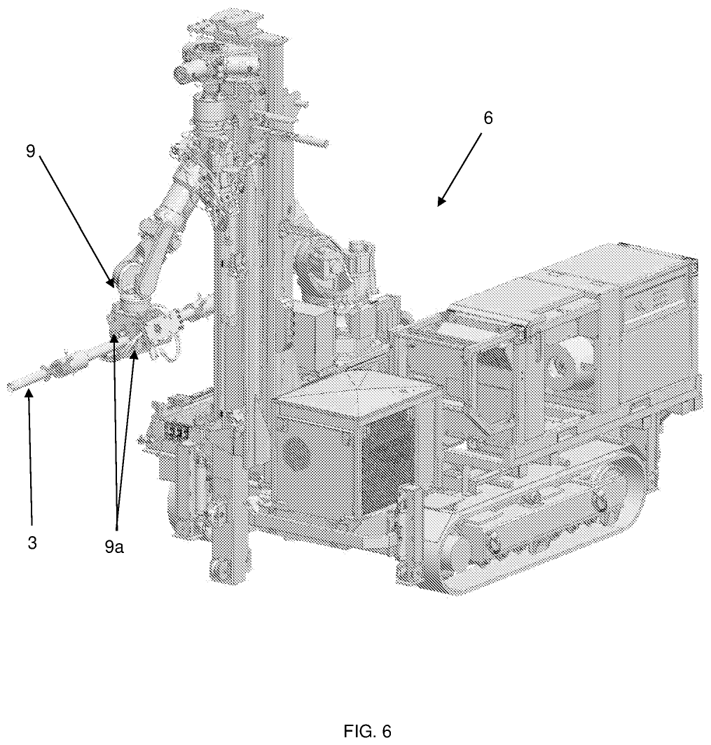

FIG. 6 illustrates an isometric view of a drilling rig 6 according to an embodiment of the present invention. In this Figure, it may be more clearly seen that the gripper 9 comprises at least two grip wheels 9a for gripping a drill rod 3. The movement of the robotic arm 10 has 7 degrees of freedom (7 DOF) to enable its movement during drill rod handling.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or can embodiment' means that a particular feature, structure, or characteristic described in connection with the embodiment is included in at least one embodiment of the present invention. Thus, the appearance of the phrases ‘in one embodiment’ or in an embodiment' in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A system for handling drill rods comprising:
a rod carrier comprising a cassette body configured for storing at least one drill rod and an actuating mechanism configured to move the drill rod between a first position in the cassette body and a second position;
a drilling rig comprising a chassis, and a mast adapted to receive the drill rod; and
a manipulator including a gripper adapted to grip the drill rod, the manipulator being configured to move the drill rod between the second position and the mast, the manipulator adapted for movement relative to the chassis along a track located on a surface of the chassis,
wherein the system for handling drill rods also comprises at least one control unit configured to allow the manipulator to determine the location of the rod carrier and/or the drill rod and to direct handling of the drill rod between the second position and the mast.

2. The system for handling drill rods according to claim 1, wherein the manipulator comprises a robotic arm.

3. The system for handling drill rods according to claim 1, wherein the rod carrier and the drilling rig are configured for movement independently of one another.

4. The system for handling drill rods according to claim 1, wherein the rod carrier is fixedly or removably connected to the drilling rig.

5. The system for handling drill rods according to claim 1 wherein the rod carrier is mounted on the drilling rig.

6. The system for handling drill rods according to claim 1 wherein the drill rod exits the cassette body into a drill rod holder associated with the rod carrier.

7. The system for handling drill rods according to claim 6 wherein the drill rod holder is configured for movement relative to the cassette body to deliver the drill rod into the second position.

8. The system for handling drill rods according to claim 6 or claim 7 wherein the rod carrier is provided with a pair of drill rod holders.

9. A method for handling drill rods comprising:
a. positioning a rod carrier and a drilling rig in relative proximity to one another;
b. moving a drill rod from a first position in a body of the rod carrier to a second position;
c. moving a manipulator including a gripper adapted to grip the drill rod into the vicinity of the drill rod;
d. gripping the drill rod with the gripper; and
e. moving the drill rod to the mast of the drilling rig by moving the manipulator relative to a chassis of the drilling rig along a track located on a surface of the chassis.

10. The method of handling drill rods according to claim 9, wherein the rod carrier and the drilling rig are moved into relative proximity to one another via a controller operated by an operator.

11. The method of handling drill rods according to claim 9 wherein, when the rod carrier and the drilling rig are positioned in relative proximity to one another, the manipulator is capable of retrieving the drill rod from the rod carrier and moving the drill rod to the mast.

12. The method of handling drill rods according to claim 9, further comprising the step of connecting the drill rod to a drill rod string in the mast of the drilling rig to form an extended drill rod string.

13. The method of handling drill rods according to claim 9. further comprising disconnecting a drill rod from an extended drill rod string, moving the manipulator into the vicinity of the drill rod, gripping the drill rod with the manipulator, moving the drill rod from the drilling rig to the rod carrier, and placing the drill rod in the body of the rod carrier.

14. A method for handling drill rods comprising:
a. positioning a rod carrier and a drilling rig in relative proximity to one another;
b. moving a manipulator including a gripper adapted to grip the drill rod into the vicinity of the rod carrier;
c. retrieving a drill rod from the rod carrier using the manipulator;
d. moving the drill rod to the mast of the drilling rig by moving the manipulator relative to a chassis of the drilling rig along a track located on a surface of the chassis.

15. A system for handling drill rods comprising:
a rod carrier comprising a cassette body configured for storing at least one drill rod;
a drilling rig comprising a chassis, and a mast adapted to receive the drill rod; and a manipulator including a gripper adapted to grip the drill rod, the manipulator being configured to move the drill rod between the rod carrier and the mast,
wherein the system for handling drill rods also comprises at least one control unit configured to allow the manipulator to determine the location of the rod carrier and/or the drill rod and to direct handling of the drill rod between the rod carrier and the mast by moving the manipulator relative to the chassis of the drilling rig along a track located on a surface of the chassis.

16. The system for handling drill rods according to claim 15, wherein the manipulator comprises a robotic arm.

17. The system for handling drill rods according to claim 15, wherein the rod carrier and the drilling rig are configured for movement independently of one another.

18. The system for handling drill rods according to claim 15, wherein the rod carrier is fixedly or removably connected to the drilling rig.

19. The system for handling drill rods according to claim 15 wherein the rod carrier is mounted on the drilling rig.

20-22. (canceled)
